(19) United States
(12) Patent Application Publication
(10) Pub. No.: US 2015/0278545 A1
(43) Pub. Date: Oct. 1, 2015

(54) ANONYMIZATION OF CLIENT DATA

(71) Applicant: ARUBA NETWORKS, INC., Sunnyvale, CA (US)

(72) Inventor: JEAN FRANCOIS BIGRAS, Mountain View, CA (US)

(73) Assignee: ARUBA NETWORKS, INC., Sunnyvale, CA (US)

(21) Appl. No.: 14/229,814

(22) Filed: Mar. 28, 2014

(51) Int. Cl. G06F 21/62

(52) U.S. Cl. CPC G06F 21/6245

(57) ABSTRACT

The present disclosure discloses a method and network device for providing anonymization of client data in a wireless local area network. Specifically, a network device adds a first client device identifier containing private personal data (e.g., a Media Access Control (MAC) address and/or an Internet Protocol (IP) address) into a large data file, and sends at least a portion of the large data file as input to a one-way hash function to generate a second client device identifier for the client device. The network device then provides to a third party client context information with the second client device identifier without providing the first client device identifier. No private personal data can be derived from the second client device identifier. Thus, the disclosed system protects wireless clients' privacy while facilitating analytics of client data by an external third party.

### FIELD

The present disclosure relates to privacy protection in a wireless local area network (WLAN). In particular, the present disclosure relates to anonymization of client data in WLANs to protect client privacy.

### BACKGROUND

Wireless digital networks, such as networks operating under the current Electrical and Electronics Engineers (IEEE) 802.11 standards, are spreading in their popularity and availability. In a society with a high demand for digital connectivity on the move, there is an increasing demand for public wireless local area network (WLAN) services to be made widely available. Businesses are understandably keen to meet that demands. However, there are a number of key areas that WLAN providers should comply with before offering wireless services to the public.

For example, in a wireless local area network (WLAN) deployment, a number of clients can be connected to the same wireless network via one or more access points. Thus, network devices, such as access points, will acquire knowledge of client-specific identification data, e.g., a client's Media Access Control (MAC) address, a client's Internet Protocol (IP) address, etc. Because such client-specific identification data can uniquely identify a client device, they are considered as personal data that are protected by privacy laws and regulations in many jurisdictions.

Particularly, in many European countries, wireless local area network (WLAN) providers shall not personal data with a third party, e.g., an airport, a restaurant, or any other public venues. For example, the Data Retention Regulations 2009 (EU Directive) place obligations on “public communications providers” to retain certain user data generated or processed in the United Kingdom for twelve months from the date of the communication in question. The definition of “public communications provider” can include public WLAN providers. In addition to the potential data retention obligations, public WLAN providers also need to comply with Data Protection Act 1998 (DPA 1998) when they process personal data about individuals. The DPA 1998 governs all use of personal data, including its mere storage and transmission.

Therefore, it is important for WLAN providers to deploy an effective mechanism for anonymization of client data in WLAN and to offer protection of clients' privacy.

### BRIEF DESCRIPTION OF THE DRAWINGS

The present disclosure may be best understood by referring to the following description and accompanying drawings that are used to illustrate embodiments of the present disclosure.

FIG. 1 shows exemplary anonymization of client data according to embodiments of the present disclosure.

FIGS. 2A-2E illustrate exemplary steps of anonymization of client data according to embodiments of the present disclosure.

FIG. 3 illustrates exemplary usage of anonymized client data according to embodiments of the present disclosure.

FIGS. 4A-4B illustrate exemplary processes for anonymization of client data according to embodiments of the present disclosure.

FIG. 5 is a block diagram illustrating an exemplary system for anonymization of client data according to embodiments of the present disclosure.

### DETAILED DESCRIPTION

In the following description, several specific details are presented to provide a thorough understanding. While the context of the disclosure is directed to privacy protection techniques in wireless network, one skilled in the relevant art will recognize, however, that the concepts and techniques disclosed herein can be practiced without one or more of the specific details, or in combination with other components, etc. In other instances, well-known implementations or operations are not shown or described in details to avoid obscuring aspects of various examples disclosed herein. It should be understood that this disclosure covers all modifications, equivalents, and alternatives falling within the spirit and scope of the present disclosure.

### Overview

Embodiments of the present disclosure relate to privacy protection in a wireless local area network (WLAN). In particular, the present disclosure relates to anonymization of client data in WLANs to protect client privacy.

With the solution provided herein, the disclosed network device partitions a first identifier for a client device into a plurality of sections, and inserts each section of the plurality of sections into a respective different location within a first data file. The disclosed network device then applies a one-way hash function to at least a portion of the first data file that includes the plurality of sections to obtain a second identifier for the client device that is different than the first identifier for the client device. Next, the disclosed network device transmits a first set of information associated with client device with the section identifier. Here, both the first identifier and the second identifier uniquely correspond to the client device. However, the first identifier contains personal data that warrants privacy protections, whereas no personal data can be derived from the second identifier. Note that, personal data may include, but are not limited to, Media Access Control (MAC) addresses, Internet Protocol (IP) addresses, user names, etc.

Moreover, according to the solution herein, the disclosed network device applies a one-way hash function to at least a portion of a first data file comprising a first identifier associated with a client device to obtain a second identifier that is different than the first identifier. Then, the disclosed network device transmits the first set of information associated with the client device with the second identifier. Subsequently, the disclosed network device applies a one-way hash function to at least a portion of a second data file comprising the first identifier associated with the client device to obtain a third identifier that is different than both the first identifier and the second identifier. Here, two different identifiers can both uniquely correspond to the client device and may be used by a third party to identifier the client device at different periods of time. Neither the first identifier nor the second identifier contains any personal data associated with the client device.

Typically, the anonymization of the client data is performed by an analytics and location engine that may or may not reside on the network device prior to publishing the client data to a third party. Since the total possible number of MAC addresses is relatively limited because the length of MAC addresses is merely 6 bytes, a security attacker can easily pre-hash every single MAC address to construct a rainbow table. Because hashes are one-way operations, even if the attacker gained access to the hashed version of client's identifiers, it's not possible to reconstitute the identifier from the hash value alone. However, using pre-computed rainbow tables, which are enormous hash values for every possible combination of byte values, the attacker could proceed with the attack to several orders of magnitude faster than computing the hash values on the fly.

### Anonymization of Client Data

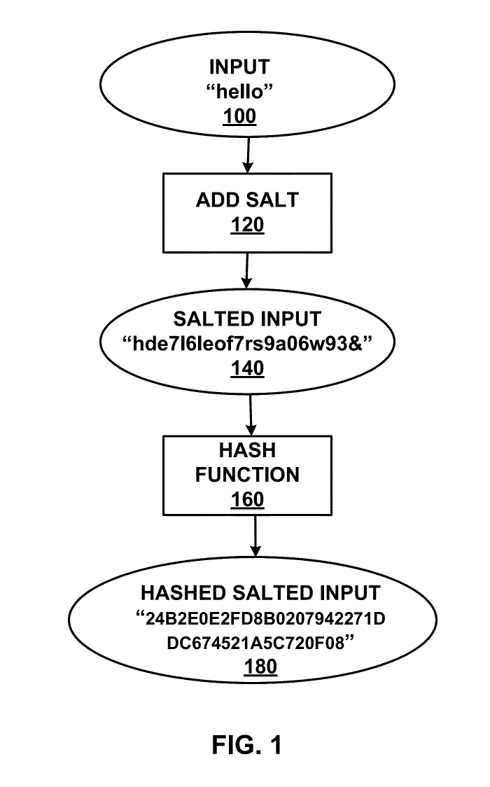

FIG. 1 shows exemplary anonymization of client data according to embodiments of the present disclosure. Client data may include any type of personal data, which includes, but is not limited to, a client's MAC address, IP address, user name, password, etc. Also, client data can be stored in any data structure as any data type, but typically can be converted to plain texts. As illustrated in FIG. 1, the disclosed system starts from receiving an input 100 that contains client data (e.g., “hello”). Input 100 may be any type of byte arrays, for example, plain text. The disclosed system then adds salt 120 to the received input 100 to generate salted text 140 (e.g., “hde7l6leof7rs9a06w93&”).

Here, a salt generally refers to a randomly generated large data file that can be used to obscure the input 100. Hereinafter, “salt,” “salt key,” and “data file” are used interchangeably to refer to a randomly generated byte array. In some embodiments, the salt can be concatenated to input 100. In some embodiments, the salt can be interlaced with input 100. For example, input 100 may be partitioned into a number of sections. Similarly, salt also can be partitioned into a number of sections. Then, each input section can be inserted before or after a corresponding salt section to generate salted input 140. Alternatively, each plain text section can be inserted into the salt to replace a corresponding salt section to generate salted input 140.

Next, the disclosed system applies a one-way hash function 160 to generate a hashed salted input 180 (e.g., “24B2E0E2FD8B0207942271DDC674521A5C720F08”) that uniquely corresponds to plain text 100. Because a one-way hash function 160 is used, the generated hashed salted text 180 cannot be converted back to the original plain text 100. In some embodiments, SHA-1 is used as the one-way hashing algorithm that produces a 20-byte long output from an input of any number of bytes. The longer the input is, the more difficult it is to revert the output. In some embodiments, the disclosed system will use at least 512 bytes as input to the one-way hashing function.

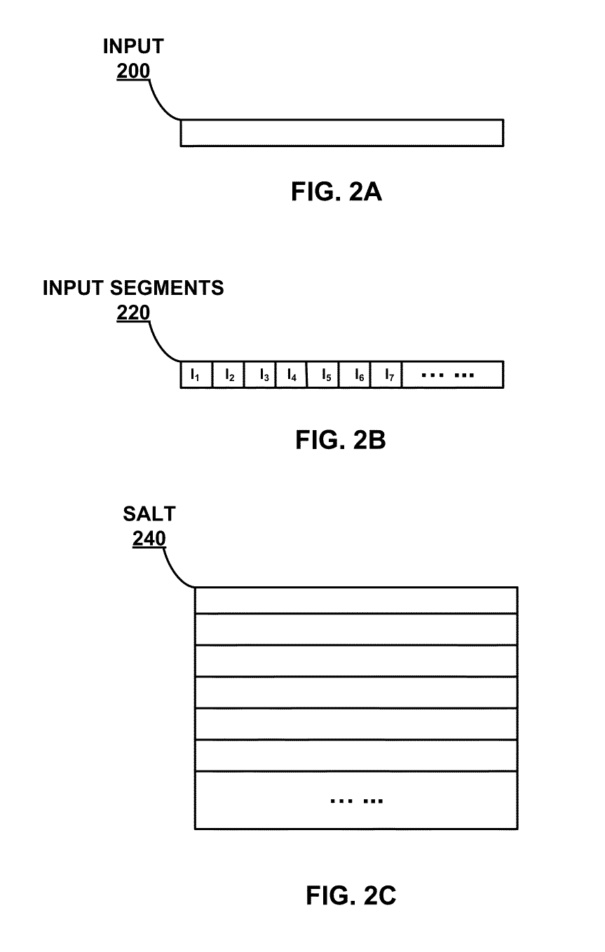

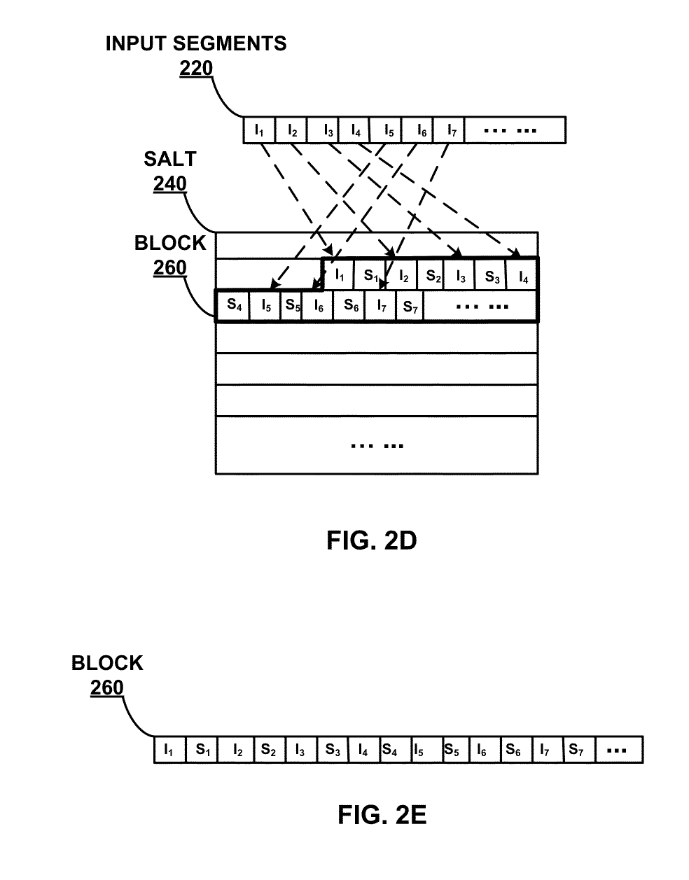

FIGS. 2A-2E illustrate a detailed example of anonymization of client data according to embodiments of the present disclosure. Although only one particular mechanism of client data anonymization is illustrated in FIG. 2A-2E, it shall be understood that many other ways of client data anonymization exist without departing from the spirit of present invention.

Specifically, FIG. 2A illustrates an input 200 that represent client data including personal data under privacy protection. Input 200 is usually a relatively small string, e.g., 6 bytes long. As illustrated in FIG. 2B, input 200 is subsequently divided into a plurality of input segments 220 (e.g., I₁, I₂, I₃, I₄, I₅, I₆, I₇, . . . ). Each input segment may be of an equal size or a different size, but input segments 220 maintain the same order as in the original input 200. Moreover, FIG. 2C illustrates a salt 240 according to embodiments of the present disclosure. Salt 240 is a randomly generated byte array and usually is fairly large in size (e.g., 512 bytes).

FIG. 2D illustrates one way to insert input segments 220 into salt 240. Specifically, the value of the first segment of input segments 220 (e.g., I₁) may be used as an offset to location the position where the first segment (e.g., I₁) will be inserted. In addition, salt 240 can be divided using any algorithm or at a fixed length into a plurality of sections, e.g., S₁, S₂, S₃, S₄, S₅, S₆, S₇, etc. A corresponding input segment from input segments 220 can be inserted before or after each section of salt 240 to form a new block 260. In this example, as illustrated in FIG. 2E, block 260 consists of I₁, S₁, I₂, S₂, I₃, S₃, I₄, S₄, I₅, S₅, I₆, S₆, I₇, S₇, etc., in their respective order. Moreover, block 260 can be used as an input to a predefined one-way hashing function (e.g., SHA-1, etc.) to generate a 20-byte message digest, which is also an irreversible hashed block without the knowledge of the salt and the algorithms that determine how to divide the salt into the plurality of sections and where to insert each of the input segment from input segments 200.

### Use of Anonymized Client Data

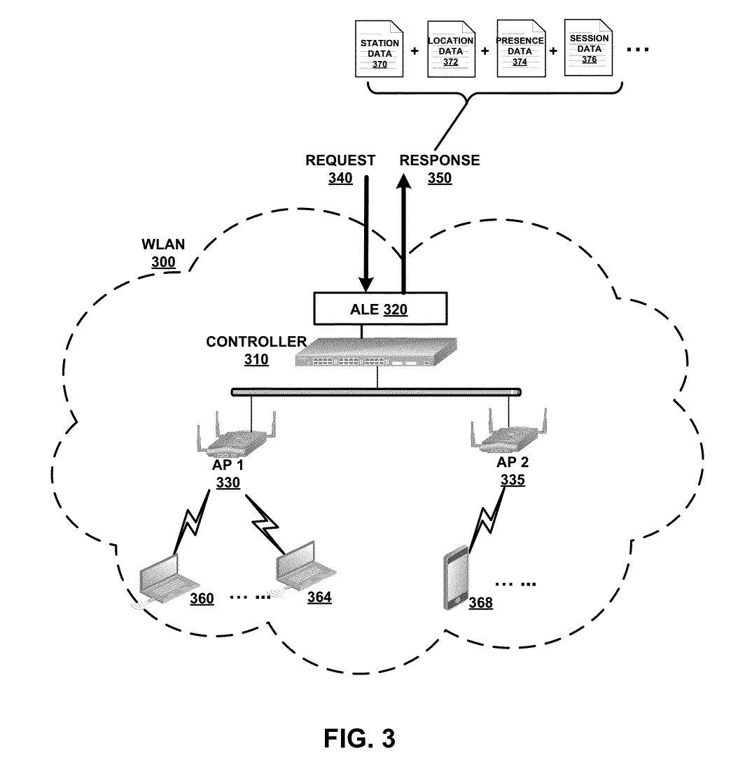

FIG. 3 illustrates exemplary usage of anonymized client data according to embodiments of the present disclosure. FIG. 3 includes a controller 310 in a wireless local area network (WLAN) 300. WLAN 300 may be also connected to Internet or another external network. Controller 310 is communicatively coupled with one or more access points (APs), such as AP1 330 and AP2 335, to provide wireless network services by transmitting network packets, including frames containing sensitive personal data to a number of wireless client devices, such as client devices 360-364 and 368, etc.

Network according to embodiments of the present disclosure may operate on a private network including one or more local area networks. The local area networks may be adapted to allow wireless access, thereby operating as a wireless local area network (WLAN). In some embodiments, one or more networks may share the same extended service set (ESS) although each network corresponds to a unique basic service set (BSS) identifier.

In addition, network depicted in FIG. 3 may include multiple network control plane devices, such as network controllers, access points or routers capable of controlling functions, etc. Each network control plane device may be located in a separate sub-network. The network control plane device may manage one or more network management devices, such as access points or network servers, within the sub-network.

Moreover, in the exemplary network depicted in FIG. 3, a number of client devices are connected to the access points in the WLAN. For example, client devices 360-364 are associated with AP1 330, and client devices, such as client device 368, are associated with AP2 335. Note that, client devices may be connected to the access points via wired or wireless connections. During operations, a wireless station, such as client device 360, client device 364, or client device 368, is associated with a respective access point, e.g., access point AP1 330, access point AP2 335, etc.

Further, WLAN 300 includes an analytics and location engine (ALE) 320. ALE 320 may be a part of controller 310 or may be an external module to controller 320. ALE 320 is able to receive, store, aggregate, process, and analyze location data as well as other client data. For example, ALE 320 can produce a client device's location on a map (e.g., a (x,y) coordinate) as well as a context. The context may indicate, for example, whether the client device is an Apple device or a Windows device, the user name associated with the client device, the role associated with the client device (e.g., an employee, a guest, a VIP) etc. In each message, the ALE includes a hashed salted identifier such that the receiver of the message can derive a relation between the client device and its contextual data. For example, with the location context data and unique device identifiers from ALE 320, it is possible to determine how many unique devices are located within a specific zone of interests in a public venue.

More specifically, ALE can produce a message digest using a salt key along with a one-way hashing algorithm (such as, SHA-1 algorithm). Original bits of an ALE's input buffer are inserted into the salt array. An offset can also be applied based on, e.g., the first byte of the original message. A portion of the salt array containing all the hidden bits is then passed to the hashing algorithm (e.g., SHA-1 algorithm) to produce a message digest. Note that, the message digest prevents leakage of sensitive personal data, because the actual device identifier is not returned by ALE 320. However, the message digest still is capable of uniquely identifying a client device, because the use of salt and hash function retains the unique mapping between the client device and the output identifier (e.g., the 20-byte output from SHA-1 algorithm). During the same period of time, the same hash is used on the same input to generate the exact same output.

In some embodiments, the salt key and the hash algorithm is only used when personal data associated with a client device is being requested by an external system. For packet transmissions within WLAN 300, device client identifiers are used as usual without applying the salt and the hash function.

In some embodiments, the salt key can be changed periodically. The periodic hash change only affects the salt key. Once the salt key is changed, the new message digest will have a different value from the previous one. This will result in completely changing the final message digest, so that users could not be traced over a period of time. For example, when the changing period is set to 24 hours, the salt key will automatically be randomly changed every day. Thus, if a client device is connected to the WLAN at a public venue (e.g., airport), the client device will be seen as a different device with a new unique identifier after the salt change. As such, no third party system will be able to trace the client device beyond any 24-hour period. On the other hand, when data is collected for analytical purposes, for example, when an airport attempts to find out how many customers are using the wireless network during a 24-hour period, it does not affect the analytical outcome when a particular client device corresponds to two different identifiers during two different 24-hour periods due to the change of the salt used in computing these client device identifiers.

In one embodiment, the salt change schedule can be set by a property such as ale.hash.schedule. The ale.hash.schedule can take any of the values listed in the table below. Even though only a limited number of values are listed, the salt can be changed according to any schedule with fixed and/or flexible intervals. The table herein is provided for illustration purposes only.

| Value | Meaning |
|---|---|
| Daily | Fire at midnight every day |
| Weekly | Fire at midnight every Sunday |
| Monthly | Fire at midnight on the first day of every month |
| Hourly | Fire every hour |
| Never | Never change the hash. |

In some embodiments, anonymization can be turned off by configuration. Turning off anonymization will not prevent ALE from computing the hash of the sensitive fields. Rather, it will enable the original field to be present in the outgoing messages along with their corresponding hash. Even when anonymization is turned off, ALE is still storing MAC addresses, IP addresses, usernames, and other personal data of all client devices. In some embodiments, the stored personal data are kept separated from the anonymization logic, and thus provides the flexibility to change anonymization settings at any point of time.

Furthermore, ALE 320 can provide an application programming interface (API), which may take a request 340 from an external source and respond with a response 350. The ALE API may make the following attributes accessible by external sources: station data 370, location 372, presence 374, session data 376, etc.

A. Station Data

Station data 370 may include, but is not limited to, a device type, a user role associated with a client device, a basic service identifier (BSSID) that the client device is connected to, etc. Below is an exemplary response to a request for station data when anonymization is turned on:

{

“Station_result”:[

{

“msg”:{

“role”:“Employee”,
“bssid”:{

“addr”:“6CF37FEC1110”

},
“device_type”:“iPad”,

“hashed_sta_eth_mac”:“041CB396A0844FE3BF3A6F22B7475ED037BD972B”
,
“hashed_sta_ip_address”:“34A71F00D8A61467739009283665CE47CEC21E
1A”

},
“ts”:1393536217

}

]

}

Below is an exemplary response to a request for station data when anonymization turned off:

{

“Station_result”:

{

“msg”:{

“role”:“Employee”,

“username”:“jdoe”,
“sta_eth_mac”:{

“addr”:“6482FFBB2A35”

},

“bssid”:{

“addr”:“6CF37FEC1110”

},

“sta_ip_address”:{

“af”: “ADDR_FAMILY_INET”,
“addr”: “10.100.239.186”

},

“device_type”:“iPad”,

“hashed_sta_eth_mac”:“041CB396A0844FE3BF3A6F22B7475ED037BD972B”
,
“hashed_sta_ip_address”:“34A71F00D8A61467739009283665CE47CEC21E
1A”

},
“ts”:1393536217

}

]

}

B. Location Data

Location data 372 generally indicates the location of a client device. In some embodiments, the location may be represented as a (x, y) coordinate. In some embodiments, the location may be represented by a combination of one or more of a campus identifier, a building identifier, a floor identifier, a room identifier, etc. Below is an exemplary response to a request for location data when anonymization is turned on:

{

“Location_result”:

{

“msg”:{

“sta_location_x”:142.20001,

“sta_location_y”:173.8,
“error_level”:237,
“associated”:true,
“campus_id”:“A491E73EA7D34DEBA876AA667CB8353B”,
“building_id”:“C61C1A2C4DFF482F9DF7B07977F16E5D”,
“floor_id”:“FEE3EBCE3AA64CBA836DAB1DEB0F8385”,

“hashed_sta_eth_mac”:“A9DC16D5548079F73FA1A4A81CA243F417D90B6D”
,

“loc_algorithm”:“ALGORITHM_TRIANGULATION”

},
“ts”:1393849868

}

]

}

Below is an exemplary response to a request for location data when anonymization is turned off:

{

“Location_result”:[

{

“msg”:{

“sta_eth_mac”:{

“addr”:“002314D4D54C”

},

“sta_location_x”:142.20001,
“sta_location_y”:173.8,
“error_level”:237,
“associated”:true,
“campus_id”:“A491E73EA7D34DEBA876AA667CB8353B”,
“building_id”:“C61C1A2C4DFF482F9DF7B07977F16E5D”,
“floor_id”:“FEE3EBCE3AA64CBA836DAB1DEB0F8385”,

“hashed_sta_eth_mac”:“A9DC16D5548079F73FA1A4A81CA243F417D90B6D”
,

“loc_algorithm”:“ALGORITHM_TRIANGULATION”

},
“ts”:1393849868

}

]

}

C. Presence Data

The presence data 374 generally refers to whether a client device can be detected by the WLAN. Note that, a network device in the WLAN can detect the client device even without the client device being associated with the WLAN. For example, the client device may transmit a probe request that is received by an access point in the WLAN prior to the client device is connected to the WLAN. In such cases, the presence data of the client device will indicate that the client device is visible to the WLAN but not currently associated with the WLAN. Below is an exemplary response to a request for presence data when anonymization is turned on:

{

“Presence_result”:

{

“msg”:{

“associated”:true,

“hashed_sta_eth_mac”:“6187977C8EF3FD01826D8409658E4319325DBE64”

},
“ts”:1393850290

}

]

}

Below is an exemplary response to a request for presence data when anonymization is turned off:

{

“Presence_result”:[

{

“msg”:{

“sta_eth_mac”:{

“addr”:“FC253F661712”

},

“associated”:true,

“hashed_sta_eth_mac”:“6187977C8EF3FD01826D8409658E4319325DBE64”

},
“ts”:1393850290

}

]

}

In addition, session data 376 may indicate which application the client device is executing, how many bytes of data has been transmitted and/or received for the particular application.

Further, the anonymization configuration can also affect results of any message queue feed, such as ZeroMQ feeds. In particular, any fields with personal data will not be published to the data feed. For example, the underlined fields in the following exemplary ZeroMQ messages will not be published when the anonymization configuration is turned on.

A. Station Data Feed

seq: 127711488
timestamp: 1393873363
op: OP_UPDATE
topic_seq: 1357551
source_id: 000C291204FD
station {

sta_eth_mac {

addr: 88:1f:a1:16:06:10

}
username: jdoe@arubanetworks.com
role: Employee
bssid {

addr: 9c:1c:12:8c:6f:70

}
device_type: OS X
sta_ip_address {

af: ADDR_FAMILY_INET
addr: 10.73.90.110

}
hashed_sta_eth_mac:

041CB396A0844FE3BF3A6F22B7475ED037BD972B

hashed_sta_ip_address:

34A71F00D8A61467739009283665CE47CEC21E1A
}

B. Location Data Feed

seq: 127734160
timestamp: 1393873579
op: OP_UPDATE
topic_seq: 20548375
source_id: 000C291204FD
location {

sta_eth_mac {

addr: 54:26:96:2a:55:c3

}
sta_location_x: 1
sta_location_y: 1
error_level: 241
campus_id: 5160530A511C49ABB8C08F331B2FD89A
building_id: CECFC2EB18454F5798C9444FA84F2FFB
floor_id: B1D12F446DDA407582D1EFA791416B77
hashed_sta_eth_mac:

041CB396A0844FE3BF3A6F22B7475ED037BD972B
}

C. Presence Data Feed

seq: 127748813
timestamp: 1393873756
op: OP_ADD
topic_seq: 1696374
source_id: 000C291204FD
presence {

sta_eth_mac {

addr: bc:92:6b:2f:59:c7

}
associated: false
hashed_sta_eth_mac:

041CB396A0844FE3BF3A6F22B7475ED037BD972B
}

D. Visibility Record Feed

seq: 129178412
timestamp: 1393889861
op: OP_UPDATE
topic_seq: 43304551
source_id: 000C291204FD
visibility_rec {

client_ip {

af: ADDR_FAMILY_INET
addr: 10.73.90.110

}
dest_ip {

af: ADDR_FAMILY_INET
addr: 239.203.13.64

}
ip_proto: IP_PROTOCOL_VAL_17
app_id: 16777223
tx_pkts: 4294967355
tx_bytes: 253403070464
rx_pkts: 0
rx_bytes: 1162
hashed_client_ip:
34A71F00D8A61467739009283665CE47CEC21E1A

}

### Processes for Anonymization of Client Data

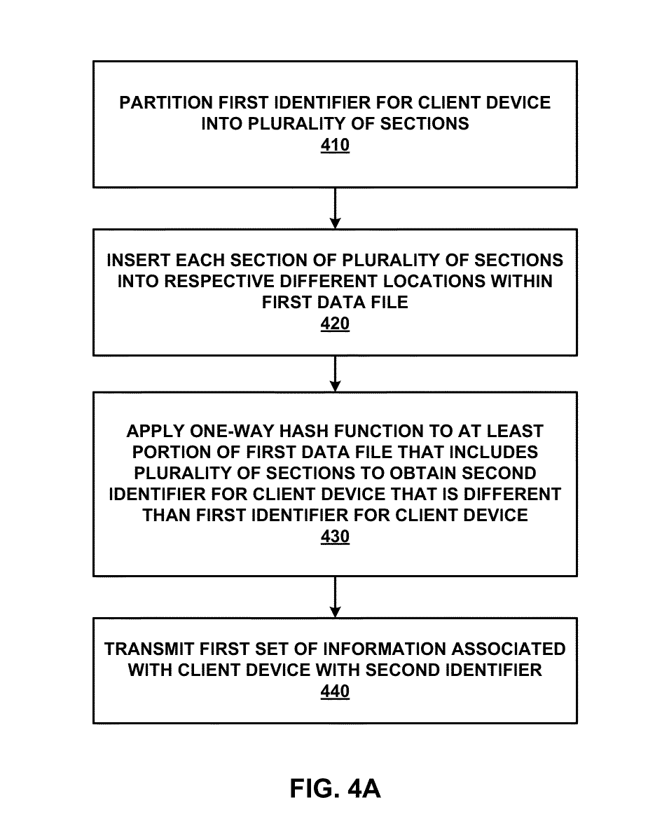

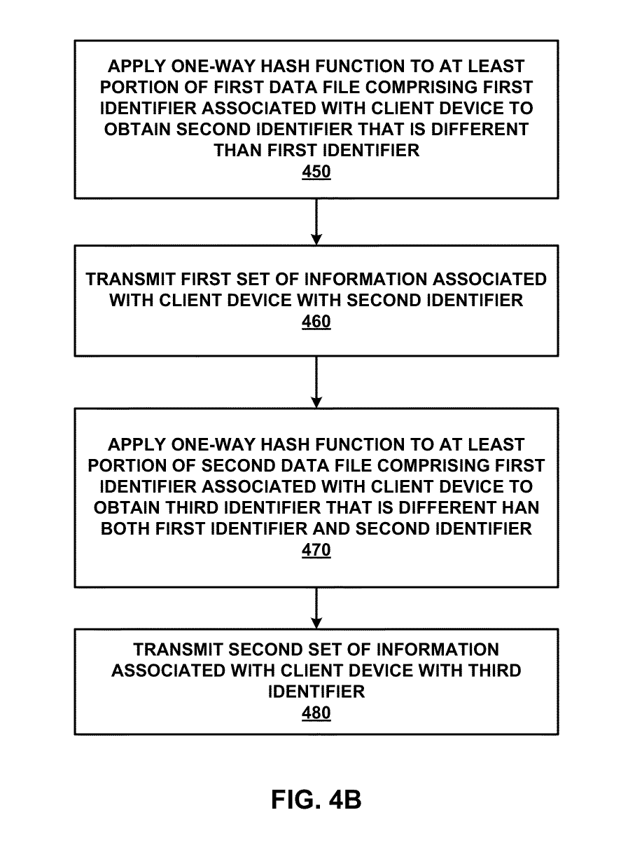

FIGS. 4A-4B illustrate exemplary processes for anonymization of client data according to embodiments of the present disclosure. As illustrated in FIG. 4A, during operations, a network device partitions a first identifier for a client device into a plurality of sections (operation 410). The network device then inserts each section of the plurality of sections into respective different locations within a first data file (operation 420). Next, the network device applies a one-way hash function to at least a portion of the first data file that includes the plurality of sections to obtain a second identifier for the client device that is different than the first identifier for the client device (operation 430). Subsequently, the network device transmits a first set of information associated with the client device with the second identifier (operation 440).

In some embodiments, the data file is a randomly generated byte array. In some embodiments, the second identifier cannot be used to compute the first identifier.

In some embodiments, the network device inserts each section into the respective location within the data file by determining an offset based on the section and using the offset of select the respective location.

In some embodiments, the network device further inserts each section of the plurality of sections into respective different locations within a second data file. Also, the network device applies the same one-way hash function to at least a portion of the second data file that includes the plurality of sections to obtain a third identifier for the client device. The third identifier for the client device is different than both the first identifier and the second identifier for the client device. The network device then transmits a second set of information associated with the client device with the third identifier. Note that, the first set and/or the second set of information may be transmitted a third party, which cannot use the second identifier and/or the third identifier to compute the first identifier.

In some embodiments, the first set of information may include location information for the client device during a first period of time, and the second set of information may include location information for the client device during a second period of time.

In some embodiments, the first set of information may include presence information for the client device during a first period of time, and the second set of information may include presence information for the client device during a second period of time.

In some embodiments, the first set of information may include session information for the client device during a first period of time, and the second set of information may include session information for the client device during a second period of time.

FIG. 4B shows another flowchart for an exemplary process for anonymization of client data according to embodiments of the present disclosure. During operations, a network device applies a one-way hash function to at least a portion of a first data file including a first identifier associated with a client device to obtain a second identifier that is different than the first identifier (operation 450). The network device transmits a first set of information associated with the client device with a second identifier (operation 460). Then, the network device applies the one-way hash function to at least a portion of a second data file including the first identifier associated with the client device to obtain a third identifier that is different than both the first identifier and the second identifier (operation 470). The network device subsequently transmits a second set of information associated with the client device with the third identifier (operation 480). In some embodiments, the first set of information includes information corresponding to the client device for a first period of time; and, the second set of information includes information corresponding to the client device for a second period of time.

### System for Anonymization of Client Data

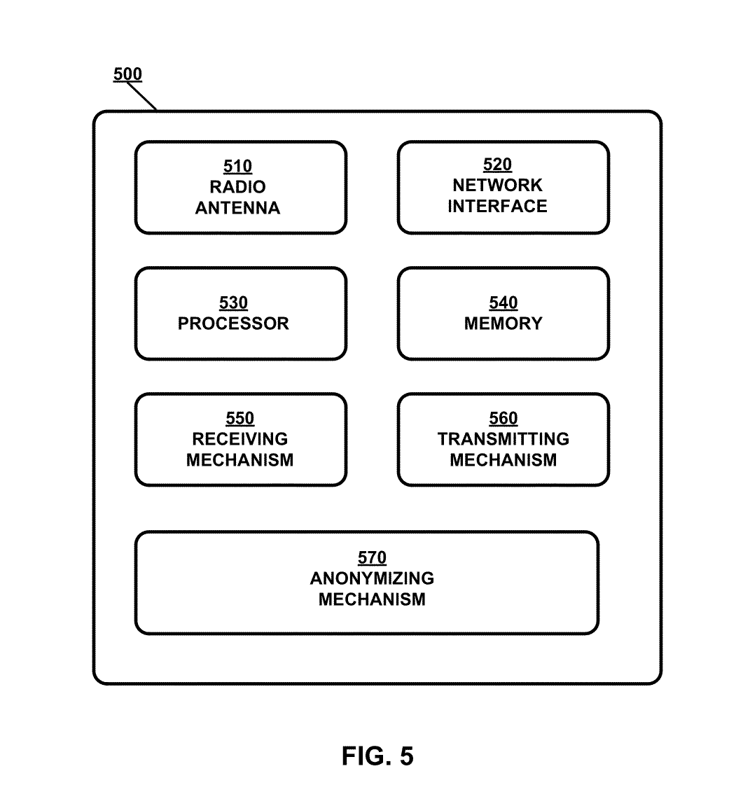

FIG. 5 is a block diagram illustrating a system for anonymization of client data according to embodiments of the present disclosure.

Network device 500 includes at least one or more radio antennas 510 capable of either transmitting or receiving radio signals or both, a network interface 520 capable of communicating to a wired or wireless network, a processor 530 capable of processing computing instructions, and a memory 540 capable of storing instructions and data. Moreover, network device 500 further includes an receiving mechanism 550, a transmitting mechanism 560, and an anonymizing mechanism 570, all of which are in communication with processor 530 and/or memory 540 in network device 500. Network device 500 may be used as a client system, or a server system, or may serve both as a client and a server in a distributed or a cloud computing environment.

Radio antenna 510 may be any combination of known or conventional electrical components for receipt of signaling, including but not limited to, transistors, capacitors, resistors, multiplexers, wiring, registers, diodes or any other electrical components known or later become known.

Network interface 520 can be any communication interface, which includes but is not limited to, a modem, token ring interface, Ethernet interface, wireless IEEE 802.11 interface, cellular wireless interface, satellite transmission interface, or any other interface for coupling network devices.

Processor 530 can include one or more microprocessors and/or network processors. Memory 540 can include storage components, such as, Dynamic Random Access Memory (DRAM), Static Random Access Memory (SRAM), etc.

Receiving mechanism 550 generally receives one or more network messages via network interface 520 or radio antenna 510 from a wireless client. The received network messages may include, but are not limited to, requests and/or responses, beacon frames, management frames, control path frames, and so on. In some embodiments, receiving mechanism 550 receives a data file that serves as a salt, whose value may be changed periodically based on configurations by a network administrator.

Transmitting mechanism 560 generally transmits messages, which include, but are not limited to, requests and/or responses, beacon frames, management frames, control path frames, and so on. Transmitting mechanism 560 may transmit packets containing anonymized client data. In particular, transmitting mechanism 560 may transmit a first set of information associated with a client device with an identifier. Moreover, transmitting mechanism 560 may transmit a second set of information associated with the client device with another identifier.

Specifically, in some embodiments, the first set of information includes location information for the client device during a first period of time; and, the second set of information includes location information for the client device during a second period of time.

In some embodiments, the first set of information includes presence information for the client device during a first period of time; and, the second set of information comprises presence information for the client device during a second period of time.

In some embodiments, the first set of information includes session information for the client device during a first period of time; and, the second set of information includes session information for the client device during a second period of time.

In some embodiments, the first set of information is transmitted to a third party, which cannot use the transmitted identifier to compute the original identifier.

Anonymizing mechanism 570 generally performs various operations to anonymize client data. For example, anonymizing mechanism 570 partitions a first identifier for a client device into a plurality of sections. Anonymizing mechanism 570 then inserts each section of the plurality of sections into respective different locations within a first data file. Further, anonymizing mechanism 570 can apply a one-way hash function to at least a portion of the first data file that includes the plurality of sections to obtain a second identifier for the client device that is different than the first identifier for the client device. Note that, the data file may be a randomly generated byte array. Also, it is important to note that, the second identifier cannot be used to compute the first identifier.

In some embodiments, anonymizing mechanism 570 inserts each section into the respective location within the data file by determining an offset based on the section and using the offset of select the respective location.

In some embodiments, anonymizing mechanism 570 inserts each section of the plurality of sections into respective different locations within a second data file. Then, anonymizing mechanism 570 applies the same one-way hash function to at least a portion of the second data file that includes the plurality of sections to obtain a third identifier for the client device. The third identifier is different than the first identifier for the client device and different than the second identifier for the client device.

In some embodiments, the second identifier is used by transmitting mechanism 560 to transmit a first set of information; and, the third identifier is used by transmitting mechanism 560 to transmit a second set of information associated with the client device. The first set of information includes location, presence, and/or session information for the client device during a first period of time; whereas the second set of information includes location, presence, and/or session information for the client device during a second period of time.

The present disclosure may be realized in hardware, software, or a combination of hardware and software. The present disclosure may be realized in a centralized fashion in one computer system or in a distributed fashion where different elements are spread across several interconnected computer systems coupled to a network. A typical combination of hardware and software may be an access point with a computer program that, when being loaded and executed, controls the device such that it carries out the methods described herein.

The present disclosure also may be embedded in non-transitory fashion in a computer-readable storage medium (e.g., a programmable circuit; a semiconductor memory such as a volatile memory such as random access memory “RAM,” or non-volatile memory such as read-only memory, power-backed RAM, flash memory, phase-change memory or the like; a hard disk drive; an optical disc drive; or any connector for receiving a portable memory device such as a Universal Serial Bus “USB” flash drive), which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

As used herein, “network device” generally includes a device that is adapted to transmit and/or receive signaling and to process information within such signaling such as a station (e.g., any data processing equipment such as a computer, cellular phone, personal digital assistant, tablet devices, etc.), an access point, data transfer devices (such as network switches, routers, controllers, etc.) or the like.

As used herein, “access point” (AP) generally refers to receiving points for any known or convenient wireless access technology which may later become known. Specifically, the term AP is not intended to be limited to IEEE 802.11-based APs. APs generally function as an electronic device that is adapted to allow wireless devices to connect to a wired network via various communications standards.

As used herein, the term “interconnect” or used descriptively as “interconnected” is generally defined as a communication pathway established over an information-carrying medium. The “interconnect” may be a wired interconnect, wherein the medium is a physical medium (e.g., electrical wire, optical fiber, cable, bus traces, etc.), a wireless interconnect (e.g., air in combination with wireless signaling technology) or a combination of these technologies.

As used herein, “information” is generally defined as data, address, control, management (e.g., statistics) or any combination thereof. For transmission, information may be transmitted as a message, namely a collection of bits in a predetermined format. One type of message, namely a wireless message, includes a header and payload data having a predetermined number of bits of information. The wireless message may be placed in a format as one or more packets, frames or cells.

As used herein, “wireless local area network” (WLAN) generally refers to a communications network links two or more devices using some wireless distribution method (for example, spread-spectrum or orthogonal frequency-division multiplexing radio), and usually providing a connection through an access point to the Internet; and thus, providing users with the mobility to move around within a local coverage area and still stay connected to the network.

As used herein, the term “mechanism” generally refers to a component of a system or device to serve one or more functions, including but not limited to, software components, electronic components, electrical components, mechanical components, electro-mechanical components, etc.

As used herein, the term “embodiment” generally refers an embodiment that serves to illustrate by way of example but not limitation.

It will be appreciated to those skilled in the art that the preceding examples and embodiments are exemplary and not limiting to the scope of the present disclosure. It is intended that all permutations, enhancements, equivalents, and improvements thereto that are apparent to those skilled in the art upon a reading of the specification and a study of the drawings are included within the true spirit and scope of the present disclosure. It is therefore intended that the following appended claims include all such modifications, permutations and equivalents as fall within the true spirit and scope of the present disclosure.

While the present disclosure has been described in terms of various embodiments, the present disclosure should not be limited to only those embodiments described, but can be practiced with modification and alteration within the spirit and scope of the appended claims. Likewise, where a reference to a standard is made in the present disclosure, the reference is generally made to the current version of the standard as applicable to the disclosed technology area. However, the described embodiments may be practiced under subsequent development of the standard within the spirit and scope of the description and appended claims. The description is thus to be regarded as illustrative rather than limiting.

1. A non-transitory computer readable medium comprising instructions which, when executed by one or more hardware processors of a computing device, cause the computing device to:
salt an original identifier of a client device such that random or pseudorandom data is concatenated with or inserted between sections of the original identifier to produce a salted identifier;
apply a one-way hash function to the salted identifier to obtain a hashed identifier for the client device that is different than the original identifier for the client device; and
transmit a first set of information associated with the client device with the hashed identifier in place of the original identifier of the client device.

2. The medium of claim 1, wherein the random or pseudorandom data is a randomly generated byte array.

3. The medium of claim 1, wherein salting the original identifier comprises: determining offsets based on the value of respective sections and using the offsets to select a portion of the random or pseudorandom data to insert between the sections of the original identifier.

4. The medium of claim 1, wherein the hashed identifier cannot be used to compute the original identifier.

5. The medium of claim 1, wherein the instructions further cause the computing device to:
salt the original identifier of the client device such that another set of random or pseudorandom data is concatenated with or inserted between sections of the original identifier to produce a new salted identifier;
apply the one-way hash function to the new salted identifier to obtain a new hashed identifier for the client device that is different than the original identifier for the client device; and
transmit a second set of information associated with the client device with the new hashed identifier in place of the original identifier of the client device.

6. The medium of claim 5, wherein the first set of information comprises location information for the client device during a first period of time, and wherein the second set of information comprises location information for the client device during a second period of time.

7. The medium of claim 5,
wherein the first set of information comprises presence information for the client device during a first period of time, and wherein the second set of information comprises presence information for the client device during a second period of time, wherein the presence information indicates whether the client device is detected by a network during either the first period of time or the second period of time; and/or
wherein the first set of information comprises network session information for the client device during a first period of time, and wherein the second set of information comprises network session information for the client device during a second period of time.

8. The medium of claim 1, wherein the transmitting operation comprises transmitting the first set of information to a third party, wherein the third party cannot use the hashed identifier to compute the original identifier.

9. A non-transitory computer readable medium comprising instructions which, when executed by one or more hardware processors, cause the hardware processors to:
apply a one-way hash function to a salted identifier to produce a hashed identifier, wherein the salted identifier comprises a plurality of sections of an original identifier of a client device concatenated with or separated by random or pseudorandom segments of data, wherein the hashed identifier is different than the original identifier;
transmit a first set of information associated with the client device with the salted identifier in place of the original identifier;
apply the one-way hash function to a new salted identifier to produce a new hashed identifier, wherein the new salted identifier comprises a plurality of sections of the original identifier of the client device concatenated with or separated by new random or pseudorandom segments of data, wherein the new hashed identifier is different from the original identifier and the hashed identifier; and
transmit a second set of information associated with the client device with the new hashed identifier in place of the hashed identifier and the original identifier.

10. The medium of claim 1, wherein the first set of information comprises information corresponding to the client device for a first period of time and where the second set of information comprises information corresponding to the client device for a second period of time.

11. A system comprising:
at least one device including a hardware processor, the system configured to:
salt an original identifier of a client device such that random or pseudorandom data is concatenated with or inserted between sections of the original identifier to produce a salted identifier;
apply a one-way hash function to the salted identifier to obtain a hashed identifier for the client device that is different than the original identifier for the client device; and
transmit a first set of information associated with the client device with the hashed identifier in place of the original identifier of the client device.

12. The system of claim 11, wherein the random or pseudorandom data is a randomly generated byte array.

13. The system of claim 11, wherein salting the original identifier comprises: determining offsets based on the value of respective sections and using the offsets to select a portion of the random or pseudorandom data to insert between the sections of the original identifier.

14. The system of claim 11, wherein the hashed identifier cannot be used to compute the original identifier.

15. The system of claim 11, wherein the operations further system is further configured to:
salt the original identifier of the client device such that another set of random or pseudorandom data is concatenated with or inserted between sections of the original identifier to produce a new salted identifier;
apply the one-way hash function to the new salted identifier to obtain a new hashed identifier for the client device that is different than the original identifier for the client device; and
transmit a second set of information associated with the client device with the new hashed identifier in place of the original identifier of the client device.

16. The system of claim 15, wherein the first set of information comprises location information for the client device during a first period of time, and wherein the second set of information comprises location information for the client device during a second period of time.

17. The system of claim 15,
wherein the first set of information comprises presence information for the client device during a first period of time, and wherein the second set of information comprises presence information for the client device during a second period of time, wherein the presence information indicates whether the client device is detected by a network during either the first period of time or the second period of time; and/or
wherein the first set of information comprises network session information for the client device during a first period of time, and wherein the second set of information comprises network session information for the client device during a second period of time.

18. The system of claim 11, wherein the transmitting operation comprises transmitting the first set of information to a third party, wherein the third party cannot use the hashed identifier to compute the original identifier.

19. A system comprising:
at least one device including a hardware processor, the system configured to:
apply a one-way hash function to a salted identifier to produce a hashed identifier, wherein the salted identifier comprises a plurality of sections of an original identifier of a client device concatenated with or separated by random or pseudorandom segments of data, wherein the hashed identifier is different than the original identifier;
transmit a first set of information associated with the client device with the salted identifier in place of the original identifier;
apply the one-way hash function to a new salted identifier to produce a new hashed identifier, wherein the new salted identifier comprises a plurality of sections of the original identifier of the client device concatenated with or separated by new random or pseudorandom segments of data, wherein the new hashed identifier is different from the original identifier and the hashed identifier; and
transmit a second set of information associated with the client device with the new hashed identifier in place of the hashed identifier and the original identifier.

20. The system of claim 19, wherein the first set of information comprises information corresponding to the client device for a first period of time and where the second set of information comprises information corresponding to the client device for a second period of time.
